(19) United States
(12) Patent Application Publication
(10) Pub. No.: US 2006/0163324 A1
(43) Pub. Date: Jul. 27, 2006

(54) Method and system for spraying metallic powder on a component surface

(75) Inventors: Mark L. Hunt, Simpsonville, SC (US); Clyde R. Taylor, Laurens, SC (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/045,557

(22) Filed: Jan. 27, 2005

(51) Int. Cl. A47J 36/02

(52) U.S. Cl. 228/101

(57) ABSTRACT

A method for applying a braze material to a component surface comprises the steps of first directing a liquid spray including a binder toward the component surface, and then injecting a powder including a metallic braze material into the spray, and thereby coating the component surface with a substantially homogenous mixture of the binder and the powder.

### TECHNICAL FIELD

The present invention generally relates to spraying techniques by which metal-containing materials are applied to a component surface, and more particularly relates to methods and systems by which components are repaired or strengthened using a spraying technique.

### BACKGROUND

Turbine engines are used as the primary power source for various kinds of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, electrical generators, or other devices.

Although turbine engine blades and vanes typically have good high temperature properties and many other advantages, they are often susceptible to corrosion, oxidation, thermal fatigue and erosion damage in the high temperature environment of an operating turbine engine. Replacing damaged turbine engine components is expensive, and significant research is undergone to find cost-effective ways to repair the components and to build components that are less susceptible to damage.

Brazing is one common method for strengthening or repairing a component such as a turbine engine blade or vane, although conventional brazing methods have some practical limitations. A successful brazing method typically includes applying a uniform layer of braze material to a component surface. It can be difficult to supply the braze material at a predetermined thickness and in a uniform manner if the component has a contoured or non-horizontal surface. For example, a current brazing technique includes painting a braze material on to a surface with a brush. Yet, it is difficult for a brush to apply braze material at a desired thickness, particularly when the desired thickness would require multiple coats since additional painted coats tend to dissolve the underlying coats. Another current brazing technique includes dispensing braze paste through a syringe, but the braze paste is often too thick when supplied in this manner. Another brazing technique includes adhering a tape with braze and binder formed thereon to a component surface, and then heating the component to burn off the binder. However, the tape tends to shrink during the heating process, and the tape shrinkage can cause splits and gaps in the braze material. Sintered braze preforms are attached to the component surface in another conventional method, but there is some tendency for the preforms to pull away from or fall off the component surface.

Hence, there is a need for methods and systems for strengthening or repairing various components. There is a particular need for systems for applying braze materials that will increase a component's durability, and for efficient and cost effective methods for strengthening and repairing the components using such braze materials.

### BRIEF SUMMARY

The present invention provides a method for applying a braze material to a component surface. The method comprises the steps of first directing a liquid spray including a binder toward the component surface, and then injecting a powder including a metallic braze material into the spray, and thereby coating the component surface with a substantially homogenous mixture of the binder and the powder.

In some embodiments, additional steps are performed, such as allowing the sprayed mixture of the binder and the powder to harden at ambient temperature and pressure, and heating the sprayed component surface at a temperature that is sufficiently high to cause the binder to vaporize, and to melt the powder that includes the metallic braze material.

Other independent features and advantages of the preferred methods and systems will become apparent from the following detailed description, taken in conjunction with the accompanying drawings which illustrate, by way of example, the principles of the invention.

### BRIEF DESCRIPTION OF THE DRAWINGS

FIG. 1 is an exploded perspective view of a stator, including a stator arc segment that includes a plurality of turbine vanes;

FIG. 2 is a side view of a turbine vane as an example of a component that can be repaired using the spraying methods and apparatus of the present invention;

FIG. 3 is a spraying system that is adapted for spraying a braze material combined with a binder according to the present invention; and

FIG. 4 is a flowchart of a process for repairing or refurbishing a component surface according to the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides an improved method for refurbishing or repairing various components such as turbine vanes or other turbine components. The method employs an apparatus such as a common hand-held air-brush paint spray gun to spray a liquid binder through a nozzle, and to inject dry powder into the binder spray as it exits the nozzle and before the spray reaches the surface being repaired. The method enables the sprayed braze material to uniformly conform to the contours of the targeted component surface, and to be easily applied at a desired thickness.

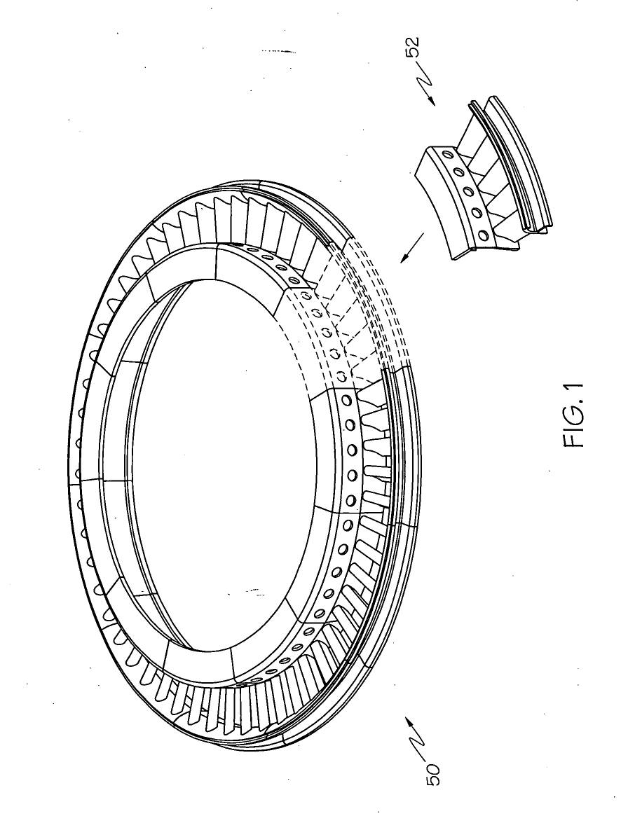

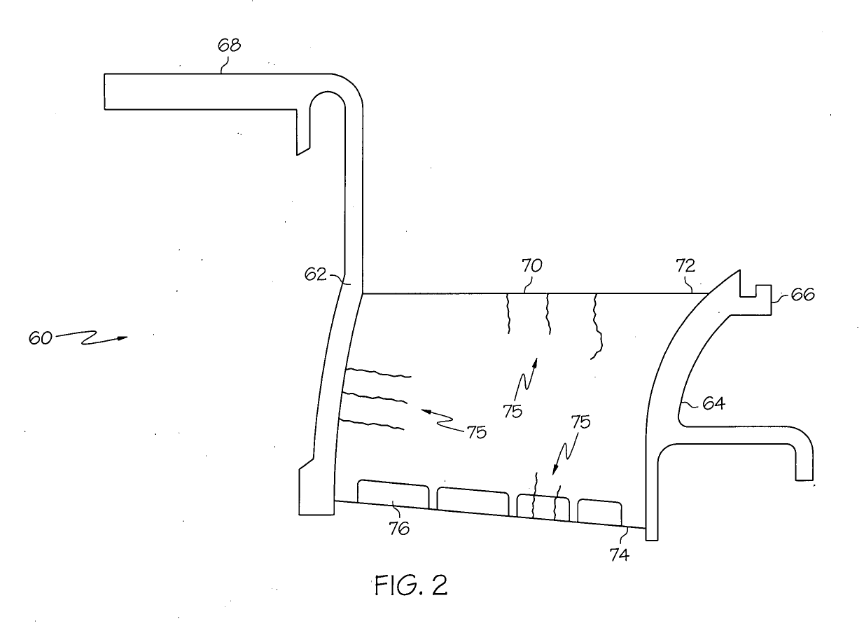

Turning now to FIG. 1, a stator 50 that is exemplary of the type that is used in turbine engines is illustrated. The stator 50 includes a plurality of arc segments 52 that are joined together. Each arc segment 52 includes one or more vanes, and a side view of an exemplary vane 60 is illustrated in FIG. 2, although turbine vanes commonly have different shapes, dimensions and sizes depending on turbine engine models and applications. The vane 60 includes several components that are particularly susceptible to friction-related erosion, wear, oxidation, corrosion, cracking, or other damage, and the brazing process of the present invention can be tailored to strengthen or repair different vane components. Among such vane components is an airfoil 70. The airfoil 70 includes a concave or angled face. In operation, hot air impinges on the concave or angled face, which turns the high velocity gas flow partially sideways to impinge on turbine blades mounted on a rotatable turbine disk. The airfoil 70 includes a leading edge 72 and a trailing edge 74 that encounter the air streaming around the airfoil 70. In some applications the vane 60 is mounted on a non-illustrated support by way of a inner bolt flange 68 that protrudes slightly downwardly from the airfoil 70 and engages with the support. A number of cooling channels 76 extend through the interior of the airfoil 70. An inner shroud 62 and outer shroud 64 provide support for the airfoil 70, and together with the airfoil 70 form at least part of the stator arc segment 52.

As mentioned previously, the processes of the present invention can be tailored to fit the vane's specific needs, which depend in part on the vane component where degradation has occurred. For example, the airfoil 70 is particularly subject to degradation due to oxidation, erosion, thermal fatigue and wear, and an exemplary repair process is used to apply a brazing material onto a cracked airfoil or one that is otherwise in need of refurbishing. FIG. 2 illustrates small cracks 75 in the airfoil 70 at the leading edge 72, trailing edge 74, and where the airfoil 70 interfaces with the inner shroud 62, and such cracks are just one type of degradation that is repaired using the spraying processes and apparatus described in detail herein. Other turbine vane components that are particularly subject to degradation include the inner shroud 62 including the inner bolt flange 68, and the outer shroud 64 including the upper flange 66.

It is emphasized again that turbine vanes are just one example of the type of turbine components that can be coated using the brazing methods and apparatus of the present invention. Blades, other shrouds, combustion liners, fuel nozzles and other turbine components can be repaired in the same manner using the spraying processes and apparatus described herein. Further, diverse components other than turbine components can be brazed using such processes and apparatus.

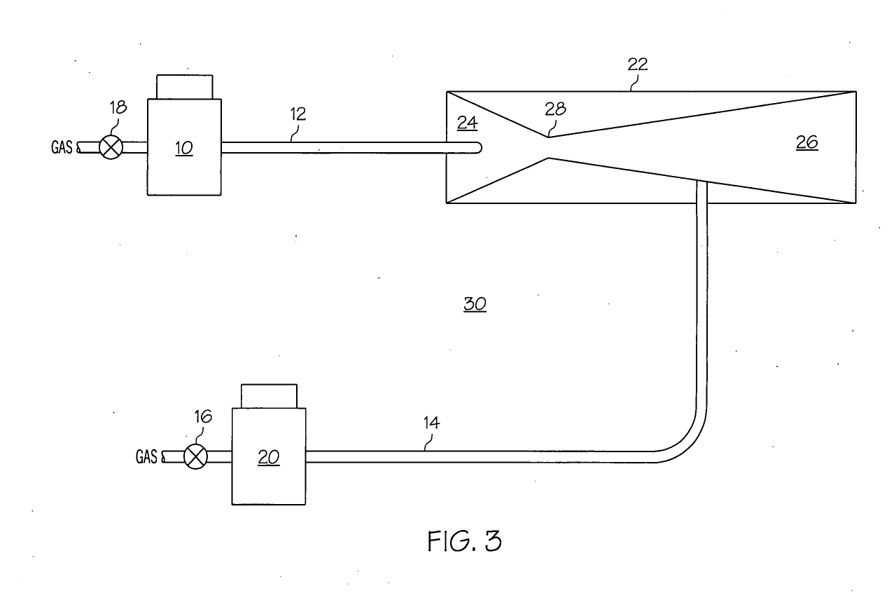

Turning now to FIG. 3, a layout of an exemplary spraying apparatus 30 for brazing a component surface is depicted. The spraying apparatus is arranged to create a stream of braze material that uniformly conforms to the contours of a targeted component surface, and that can be controlled to create a layer of braze material having a desired thickness. The sprayed braze material is also less prone than braze tape and sintered preforms to peeling or falling off of the component surface.

The spraying apparatus 30 includes a binder source 10, and a dry braze powder source 20. Liquid binder from the binder source 10 is supplied to a nozzle 22 having an inlet 24, an outlet 26, and a narrow neck or other spraying component 28 disposed between the inlet 24 and the outlet 26. More particularly, a supply line 12 that includes a pressure regulator 18 and is in fluid communication with the binder source 10 and the nozzle inlet 24 supplies liquid binder to the inlet 24. The spraying component 28 causes the liquid binder to build up pressure on the inlet side of the nozzle 22 and then eject from the outlet 26. Another supply line 14 that includes a pressure regulator 16 and is in communication with the braze powder source 20 and the nozzle outlet 26 supplies dry braze powder to the outlet 26. The dry braze powder mixes with the liquid binder as the binder is sprayed through the outlet 26 to provide a commingled spray of binder and braze powder that are uniformly mixed before being deposited on a component surface.

As discussed above, the spraying apparatus 30 in FIG. 3 combines the dry braze powder and the liquid binder as the binder exits the nozzle 22. Although the supply line 14 is illustrated to be in communication with the nozzle outlet 26, the dry braze powder can alternatively be introduced into the liquid binder spray by positioning the supply line 14 or other supplying apparatus just outside the nozzle outlet 26. Adding the dry braze powder to a liquid binder stream provides an essentially homogenous powder/binder mixture. Pre-mixed braze/binder mixtures tend to separate in a spray hopper or other container, and consequently produce sprays with inconsistent braze material concentrations. The spraying apparatus 30 overcomes this shortcoming, bypassing the pre-mixing stage altogether by mixing the dry braze powder and the liquid binder while the binder is being sprayed from the apparatus 30. Another feature that the spraying apparatus 30 provides is the ability to quickly adjust the braze powder and/or the binder concentrations in the spray using the separate pressure regulators 16, 18 since the braze material and the binder are not pre-mixed.

In an exemplary embodiment the nozzle 22 is part of a hand-held device such as a spray gun. Further, an exemplary embodiment in which the braze powder source 20 and the binder source 10 are detached from, but still in fluid communication with, the nozzle 22 allows a hand-held device that includes the nozzle to be relatively light and easily manipulated. However, other embodiments include one or more of the supplies 10, 20 in combination with the nozzle 22 as part of a single hand-held or stationary spraying apparatus.

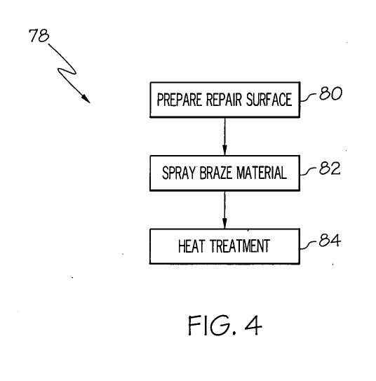

Turning now to FIG. 4, a flowchart illustrates an exemplary method 78 for repairing or refurbishing a component surface. This method includes the spraying process described above, and also includes a heat treatment to remove binder from the sprayed braze material.

The first step 80 comprises preparing the component surface for the brazing process. For example, the first step of preparing a component can involve pre-machining, degreasing and grit blasting the surface to be coated in order to remove any oxidation and dirty materials. Any suitable thermal treatment, application of solvents and other chemicals, and mechanical processes that may be necessary to adequately prepare the surface can be performed.

The next step 82 comprises spraying the mixture of binder and braze powder on the component surface. As described above, the spraying procedure includes mixing a dry braze powder with a liquid binder as the binder is sprayed through from a nozzle to provide a commingled spray of binder and braze powder that are uniformly mixed. In an exemplary embodiment, the mixture is directly applied to the component surface without intermediate compounds or materials between the component surface and the sprayed mixture.

The spraying step 82 generally repairs the component and returns the component to its desired dimensions. Any suitable binder having a viscosity that allows for spraying can be used during the spraying step 82, and exemplary binders include known braze cements such as those sold under the trade names Nicrobraz Cement 320 manufactured by Wall Colmonoy, Inc. of Madison Heights, Mich., and Vitta A-10 Braz-Cement manufactured by Vitta Corporation of Bethel, Conn. Vitta A-10 Braz-Cement is a water-based moderate viscosity liquid cement designed for general purpose brazing applications, and containing no solvents other than water. Nicrobraz Cement 320 is also a water-based cement.

Likewise, any suitable metallic braze powder material may be used, and exemplary metallic braze materials include nickel and/or cobalt-based braze alloy powders that may be mixed with other base materials or high melt alloy powders. An exemplary spraying step is performed at ambient temperature and pressure, and does not require an electrical or plasma treatment to the binder or braze material either before or during the spraying process.

The next step 84 involves performing a brazing heat treatment on the brazed component. In an exemplary embodiment the brazing heat treatment is performed under a vacuum. The heat treatment is preferably performed after the sprayed braze powder has had time to harden at ambient temperature and pressure. In such an embodiment, the sprayed braze powder need not completely dry before performing the heat treatment, but some hardening due to solidification of the sprayed braze powder does occur first. Heating the component allows the binder to vaporize, leaving the powder to melt and braze to the component surface. Therefore, the heat treatment homogenizes the microstructure of the braze coating and improves the bonding strength between the braze coating and the component surface.

The present invention thus provides methods and apparatus for spraying a liquid binder through a nozzle by which the sprayed braze material uniformly conforms to the contours of the targeted component surface, and to be easily applied at a desired thickness. The repairing and refurbishing methods and apparatus restore the component and prevent subsequent degradation from occurring, thereby prolonging the component's operational life.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for applying a braze material to a component surface, comprising the steps of:
directing a liquid spray comprising a binder toward the component surface; and
injecting a powder comprising a metallic braze material into the spray, and thereby coating the component surface with a substantially homogenous mixture of the binder and the powder.

2. The method according to claim 1, further comprising the step of:
vaporizing the binder from the sprayed component surface.

3. The method according to claim 2, further comprising the step of:
melting at least the metallic braze material on the sprayed component surface.

4. The method according to claim 2, further comprising the step of:
allowing the sprayed mixture of the binder and the powder to harden at ambient temperature and pressure before performing the heating step.

5. The method according to claim 1, wherein the binder is a water-based cement.

6. The method according to claim 1, wherein the powder comprises a nickel-based braze alloy.

7. The method according to claim 1, wherein the powder comprises a cobalt-based braze alloy.

8. The method according to claim 1, wherein the braze material is applied to the component surface at ambient pressure and temperature.

9. The method according to claim 1, wherein the component to which the braze material is applied is a turbine engine component.

10. The method according to claim 9, wherein the turbine engine component is a stator vane.

11. A method for applying a braze material to a component surface, comprising the steps of:
directing a liquid spray comprising a binder toward the component surface;
injecting a powder comprising a metallic braze material into the spray, and thereby coating the component surface with a substantially homogenous mixture of the binder and the powder; and
heating the sprayed component surface.

12. The method according to claim 11, wherein the heating step vaporizes the binder and melts at least the metallic braze material.

13. The method according to claim 11, wherein the binder is a water-based cement.

14. The method according to claim 11, wherein the powder comprises a nickel-based braze alloy.

15. The method according to claim 11, wherein the powder comprises a cobalt-based braze alloy.

16. The method according to claim 11, wherein the braze material is applied to the component surface at ambient pressure and temperature.

17. The method according to claim 11, wherein the component to which the braze material is applied is a turbine engine component.

18. The method according to claim 17, wherein the turbine engine component is a stator vane.

19. A method for applying a braze material to a component surface, comprising the steps of:
directing a liquid spray comprising a binder toward the component surface;
injecting a powder comprising a metallic braze material into the spray, and thereby coating the component surface with a substantially homogenous mixture of the binder and the powder;
allowing the sprayed mixture of the binder and the powder to harden at ambient temperature and pressure; and
heating the sprayed component surface, and thereby vaporizing the binder and melting at least the metallic braze material.
